(19) United States
(12) Patent Application Publication
(10) Pub. No.: US 2022/0006409 A1
(43) Pub. Date: Jan. 6, 2022

(54) HAPTIC INTERFACE

(71) Applicants: SORBONNE UNIVERSITE, Paris (FR); CENTRE NATIONAL DE LA RECHERCHE SCIENTIFIQUE, Paris (FR)

(72) Inventors: Vincent HAYWARD, Paris (FR); Sinan HALIYO, Paris (FR); Stéphane REGNIER, Bois-Colombes (FR); Antoine WEILL DUFLOS, Auffargis (FR)

(21) Appl. No.: 17/292,561

(22) PCT Filed: Nov. 7, 2019
(86) PCT No.: PCT/EP2019/080463

§ 371 Date: May 10, 2021

(30) Foreign Application Priority Data
Nov. 12, 2018 (FR) 1860422

(51) Int. Cl. H02P 25/032; G08B 6/00

(52) U.S. Cl. CPC H02P 25/032; G08B 6/00

(57) ABSTRACT

An interface with haptic force feedback, including a controller arranged and/or programmed to receive an initial command designed to control an actuator so that a force exerted by the actuator is equal to an initial low-frequency part F0(t) plus an optional high-frequency part; the initial command transformed into a command in which the initial low-frequency part F0(t) is transformed into a modified low-frequency part F(t) which follows in amplitude a decreasing function and for which, over any time interval of duration Δt between an instant t and an instant t+Δt, the modified low-frequency part F(t) decreases by a value X of less than or equal to 10% of the initial value of the modified low-frequency part of the force F(t) at the instant t, the duration Δt of the time interval being greater than or equal to 0.3 second; control the actuator according to the transformed command.

### TECHNICAL FIELD

The present invention relates to a haptic interface. It also relates to a method for controlling this haptic interface.

Such a haptic interface according to the invention makes it possible in particular to save energy.

### STATE OF THE PRIOR ART

Haptic interfaces are known that are arranged to exert a force, typically on a hand or a finger of a user.

A crucial problem for commercial production of these interfaces is the dimensioning of motors capable of withstanding the force exerted by their users. Even in the use case of transmissions allowing torque to be amplified by gearing down, motors remain a principal element of the manufacturing cost of these interfaces. The dimensioning of these motors is itself determined by the need to dissipate heat produced by Joule effect of the current flowing in their windings.

The purpose of the present invention is to propose a haptic interface that is:

more energy-efficient than the state of the prior art, in particular, in dissipated energy, and/or

allows the use of motors having smaller dimensions than is the case according to the state of the prior art.

### SUMMARY OF THE INVENTION

This objective is achieved with a method for controlling an interface with haptic force feedback, said interface comprising an actuator, said method comprising:
receiving an initial command arranged for controlling the actuator so that a force exerted by the actuator or the initial command is equal to:
   an initial low-frequency portion F₀(t) comprising only frequencies less than a cut-off frequency,
   plus an optional high-frequency part F(t) comprising only frequencies greater than the cut-off frequency,
converting the initial command to a converted command in which the initial low-frequency portion F₀(t) is converted to a modified low-frequency portion F(t), this modified low-frequency portion F(t) and/or the arithmetic mean of this modified low-frequency portion F(t) having an amplitude following a decreasing function, for which, over any time interval of duration Δt between a time t and a time t+Δt, the modified low-frequency portion F(t) and/or the arithmetic mean of this modified low-frequency portion F(t) decreases by a value X less than or equal to 10% of the initial value of the modified low-frequency portion F(t) at time t, the duration Δt of the time interval being greater than or equal to 0.3 second,
controlling the actuator according to the converted command.

The cut-off frequency is:

less than or equal to 10 Hz, preferably less than or equal to 5 Hz, preferably less than or equal to 1 Hz, and/or

greater than or equal to 0 Hz, preferably greater than or equal to 0.5 Hz, preferably greater than or equal to 1 Hz.

The actuator can be:

a mechanical and/or electromagnetic motor and/or actuator,

a biological and/or chemical muscle and/or actuator.

The value X is preferably greater than or equal to 1%, preferably 5%, of the initial value of F(t) at time t.

The duration Δt of the time interval is preferably greater than or equal to 0.5 second, preferably greater than or equal to 1 second, preferably greater than or equal to 1.4 seconds, preferably greater than or equal to 2 seconds, preferably greater than or equal to 3 seconds.

The duration Δt of the time interval is preferably less than or equal to 60 seconds, preferably less than or equal to 30 seconds, preferably less than or equal to 10 seconds.

The decreasing function of the modified low-frequency portion F(t) as a function of the time t is preferably an exponential function in the form

$$F ( t ) = A \cdot exp ( ( \frac{- t}{τ} ) ) + B ,$$

the constant A being a positive real number, the constant B being a real number, the constant τ being a positive real number.

The constant τ is preferably a positive real number greater than or equal to 1 second, preferably greater than or equal to 5 seconds, preferably greater than or equal to 10 seconds.

The constant τ is preferably a positive real number less than or equal to 60 seconds, preferably less than or equal to 50 seconds, preferably less than or equal to 40 seconds.

Conversion of the initial command to a converted command preferably comprises applying a high-pass filter, preferably having a cut-off frequency:

less than 0.1 Hz and/or greater than 0.001 Hz,

preferably less than 0.05 Hz and/or greater than 0.003 Hz,

preferably less than 0.03 Hz and/or greater than 0.005 Hz,

preferably less than 0.0265 Hz and/or greater than 0.0057 Hz.

The method according to the invention can comprise measuring the force exerted by the actuator, and feedback of the force exerted by the actuator according to the converted command.

The method according to the invention can be implemented over a total duration of at least 1 second, preferably at least 1.4 seconds, preferably at least 2 seconds, preferably at least 3 seconds, preferably at least 10 seconds.

The actuator can exert forces along several axes, said method according to the invention preferably being applied to at least one of these axes.

According to yet another aspect of the invention, a haptic force feedback interface is proposed, comprising:

control means, arranged and/or programmed for:
receiving an initial command arranged for controlling an actuator so that a force exerted by the actuator or the initial command is equal to:
   an initial low-frequency portion F₀(t) comprising only frequencies less than a cut-off frequency,
   plus an optional high-frequency portion \tilde{F}(t) comprising only frequencies greater than the cut-off frequency,
converting the initial command to a converted command in which the initial low-frequency portion F₀(t) is converted to a modified low-frequency portion F(t), this modified low-frequency portion F(t) and/or the arithmetic mean of this modified low-frequency portion F(t) having an amplitude following a decreasing function, for which, over any time interval of duration Δt between a time t and a time t+Δt, the modified low-frequency portion F(t) and/or the arithmetic mean of this modified low-frequency portion F(t) decreases by a value X less than or equal to 10% of the initial value of the modified low-frequency portion F(t) at time t, the duration Δt of the time interval being greater than or equal to 0.3 second,
controlling the actuator according to the converted command.
   The cut-off frequency is:
less than or equal to 10 Hz, preferably less than or equal to 5 Hz, preferably less than or equal to 1 Hz, and/or
greater than or equal to 0 Hz, preferably greater than or equal to 0.5 Hz, preferably greater than or equal to 1 Hz.

The actuator can be:

a mechanical and/or electromagnetic motor and/or actuator,

a biological and/or chemical muscle and/or actuator.

The haptic feedback interface can comprise the actuator. This actuator is thus preferably a motor and/or a mechanical and/or electromagnetic actuator.

The value X is preferably greater than or equal to 1%, preferably 5%, of the initial value of F(t) at time t.

The duration Δt of the time interval is preferably greater than or equal to 0.5 second, preferably greater than or equal to 1 second, preferably greater than or equal to 1.4 seconds, preferably greater than or equal to 2 seconds, preferably greater than or equal to 3 seconds.

The duration Δt of the time interval is preferably less than or equal to 60 seconds, preferably less than or equal to 30 seconds, preferably less than or equal to 10 seconds.

The decreasing function of the modified low-frequency portion F(t) as a function of time t is preferably an exponential function in the form

$$F ( t ) = A \cdot exp ( ( \frac{- t}{τ} ) ) + B ,$$

the constant A being a positive real number, the constant B being a real number, the constant τ being a positive real number.

The constant τ is preferably a positive real number greater than or equal to 1 second, preferably greater than or equal to 5 seconds, preferably greater than or equal to 10 seconds.

The constant τ is preferably a positive real number less than or equal to 60 seconds, preferably less than or equal to 50 seconds, preferably less than or equal to 40 seconds.

The control means preferably comprise a high-pass filter arranged to convert the initial command to the converted command, this high-pass filter preferably having a cut-off frequency:

less than 0.1 Hz and/or greater than 0.001 Hz,

preferably less than 0.05 Hz and/or greater than 0.003 Hz,

preferably less than 0.03 Hz and/or greater than 0.005 Hz,

preferably less than 0.0265 Hz and/or greater than 0.0057 Hz.

The interface according to the invention can comprise means for measuring the force exerted by the actuator, and means for feedback of the force exerted by the actuator according to the converted command.

The control means can be arranged and/or programmed to receive the initial command, convert the initial command to the converted command, and control the actuator according to the converted command over a total duration of at least 1 second, preferably at least 1.4 seconds, preferably at least 2 seconds, preferably at least 3 seconds, preferably at least 10 seconds.

The actuator can be arranged to exert forces along several axes, the control means being preferably arranged and/or programmed to receive the initial command, convert the initial command to the converted command, and control the actuator according to the converted command along at least one of these axes.

### DESCRIPTION OF THE FIGURES AND EMBODIMENTS

Other advantages and characteristics of the invention will become apparent on reading the detailed description of non-limitative implementations and embodiments, and from the following attached drawings:

FIG. 1 is a diagrammatic view of a first interface embodiment 101 according to the invention, which is a preferred mode of implementation,

FIG. 2 is a detailed view of the control means 2 of the interface 101,

FIG. 3 is another view of the first interface embodiment 101 according to the invention,

FIGS. 4 to 8 show different variants of an embodiment of the method according to the invention implemented by the interface 101.

As these embodiments are in no way limitative, in particular, variants of the invention can be considered comprising only a selection of the characteristics described or illustrated hereinafter, in isolation from the other characteristics described or illustrated, (even if this selection is isolated within a phrase comprising these other characteristics), if this selection of characteristics is sufficient to confer a technical advantage or to differentiate the invention with respect to the state of the prior art. This selection comprises at least one, preferably functional, characteristic without structural details, and/or with only a part of the structural details if this part alone is sufficient to confer a technical advantage or to differentiate the invention with respect to the state of the prior art.

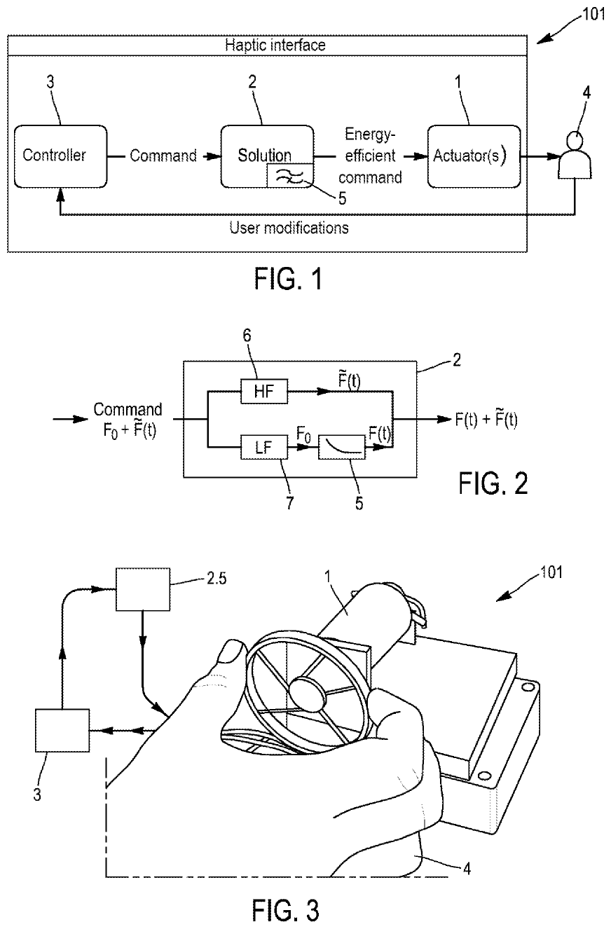

Firstly, a first embodiment of a haptic force feedback interface 101 according to the invention will be described, with reference to FIGS. 1 to 3.

The interface 101 comprises an actuator 1.

The actuator 1 is a mechanical and/or electromagnetic motor and/or actuator.

The interface 101 comprises a controller 3, arranged and/or programmed to generate an initial command arranged for controlling the actuator 1 so that a force exerted by the actuator 1 (typically on a user 4) or the initial command is equal to:
an initial low-frequency portion F₀(t) comprising only frequencies less than a cut-off frequency,
plus a high-frequency portion F(t) comprising only frequencies greater than the cut-off frequency. This high-frequency portion is optional, in the case where the initial command is constant or low-frequency.

The cut-off frequency is:

less than or equal to 10 Hz, preferably less than or equal to 5 Hz, preferably less than or equal to 1 Hz, and/or

greater than or equal to 0 Hz, preferably greater than or equal to 0.5 Hz, preferably greater than or equal to 1 Hz.

In this non-limitative embodiment, this cut-off frequency is equal to 1 Hz.

The controller 3 comprises only technical means. Typically, the controller 3 comprises at least one computer, and/or a central processing or arithmetic unit, and/or an analogue electronic circuit (preferably dedicated), and/or a digital electronic circuit (preferably dedicated), and/or a microprocessor (preferably dedicated), and/or software means.

The force exerted by the actuator 1 (typically on a user 4) is a force capable of imposing an acceleration along an axis of translation or about an axis of rotation (then referred to as torque).

The interface 101 comprises control means 2.

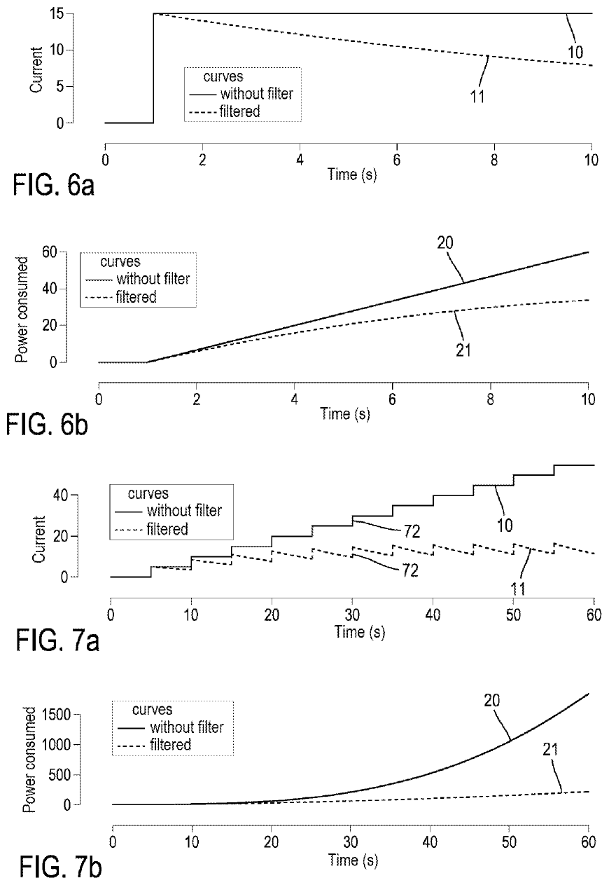

The actuator 1 is for example, as shown in FIG. 3, an interface using a single current-driven DC motor. The motor is a Maxon DCX35 motor. It is supplied by a Maxon Escon 50/5 DC servo amplifier module driven by a Teensy 3.2 board. In addition, the Teensy 3.2 board provides the communication with the control means 2.

The control means 2 comprise only technical means. Typically, the control means comprise at least one computer, and/or a central processing or arithmetic unit, and/or an analogue electronic circuit (preferably dedicated), and/or a digital electronic circuit (preferably dedicated), and/or a microprocessor (preferably dedicated), and/or software means.

The control means 2 are arranged and/or programmed for:
receiving the initial command,
converting the initial command to a converted command in which the initial low-frequency portion F₀(t) (except preferably if it is a zero constant function) is converted to a modified low-frequency portion F(t), the amplitude (or absolute value) of which follows a decreasing function, and for which, over any time interval of duration Δt between a time t and a time t+Δt, the modified low-frequency portion F(t) decreases in amplitude (or in absolute value) by a value X less than or equal to 10% of the initial value of the modified low-frequency portion F(t) at time t, the duration Δt of the time interval being greater than or equal to 0.3 second,
controlling the actuator 1 according to the converted command.

The modified low-frequency portion F(t) follows “in amplitude” a globally decreasing function over Δt, i.e.:

if this function F(t) is negative, it increases globally over Δt,

if this function F(t) is positive, it decreases globally over Δt.

Over each time interval Δt, F(t) is a function that varies differently with respect to F₀(t), except optionally over the intervals for which F₀(t) is a zero constant function. If the initial low-frequency portion F₀(t) remains zero over a time interval, the low-frequency portion F(t) preferably also remains zero over this time interval.

At each time t, F(t) and F₀(t) preferably have the same sign (positive, negative or zero).

The value X is greater than or equal to 1%, preferably 5%, of the initial value of F(t) at time t.

The duration Δt of the time interval is greater than or equal to 0.5 second, preferably greater than or equal to 1 second, preferably greater than or equal to 1.4 seconds, preferably greater than or equal to 2 seconds, preferably greater than or equal to 3 seconds. This time must be sufficiently long to avoid the user 4 feeling and becoming aware of the decrease of the force according to F(t).

The duration Δt of the time interval is less than or equal to 60 seconds, preferably less than or equal to 30 seconds, preferably less than or equal to 10 seconds. This time must be sufficiently short so that the energy saving produced is worthwhile.

The invention thus allows control of the haptic interface 101 in order to reduce the energy consumption. It is based on a feature of the haptic perception of the user 4, who is not very sensitive to the continuous or low-frequency component of the external forces and only feels the rapid variations. The invention thus allows a reduction of this continuous component F₀(t) to F(t) (which remains imperceptible to the user) and thus a reduction of the energy expended to generate F(t), which decreases with time. The invention thus makes it possible to reduce the energy consumption of the haptic interface 101 without impacting the quality of the perception of force.

Experiments by the inventors show that the sense of touch is not sensitive to slow changes of forces.

The invention presents potential applications in the production of haptic interface 101, in particular for battery-operated mobile applications and/or a commercial or psycho-physical assessment interface 101. From a general point of view it makes it possible to reduce heating of the actuator 1 and thus its energy consumption, and would be useful for all affected interfaces, regardless of their actuation technology.

Thus, the invention uses an adaptation to the forces in order to deceive the human senses of the user 4. Instead of providing a constant force F₀(t), for example, a decrease is applied to the command and thus to the force F(t), so as to reduce the energy consumption.

The invention provides a solution to heating of the actuator 1, in particular if a Foucault-current coupler is involved.

The actuator 1 can be used for a significant period without heating its coupler. The coupling coefficient is then stable and the forces produced are precise.

A preferred embodiment of the invention is to use, as decreasing function of the modified low-frequency portion F(t) as a function of time t, an exponential function in the form

$$F ( t ) = A \cdot exp ( ( \frac{- t}{τ} ) ) + B ,$$

the constant A being a positive real number, the constant B being a real number, the constant τ being a positive real number.

The constant τ is a positive real number greater than or equal to 1 second, preferably greater than or equal to 5 seconds, preferably greater than or equal to 10 seconds.

The constant τ is a positive real number less than or equal to 60 seconds, preferably less than or equal to 50 seconds, preferably less than or equal to 40 seconds.

The constant τ is typically equal to 20 seconds±10%.

This ideal τ was determined on a sample of volunteers such that these volunteers have on average a probability of less than 20% of being aware that the constant force or low frequency corresponding to F₀(t) has been replaced by a decreasing force corresponding to F(t).

In a preferred implementation of the invention, the control means 2 comprise a high-pass filter 5 arranged to convert the initial command to the converted command.

The filter 5 is placed downstream of the controller 3.

The filter 5 is placed upstream of the actuator 1.

The filter 5 is placed between the controller 3 and the actuator 1.

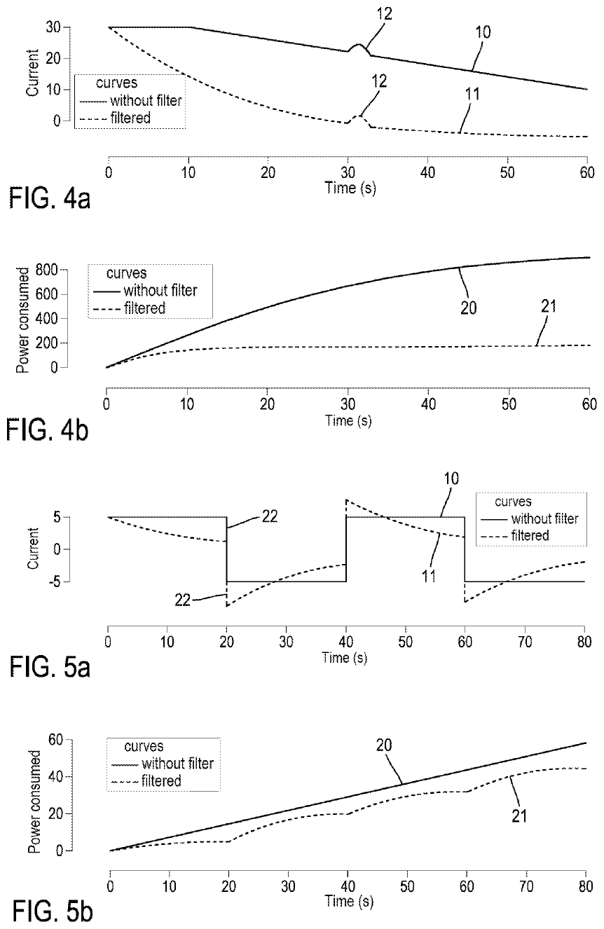

More precisely, with reference to FIG. 2, the control means 2 comprise a high-pass filter 6 arranged to select the portion of the initial command corresponding to the high-frequency portion \tilde{F}(t).

The control means 2 comprise a low-pass filter 7 arranged to select the portion of the initial command corresponding to the initial low-frequency portion F₀(t).

The high-pass filter 5 is arranged to convert the initial low-frequency portion F₀(t) to the modified low-frequency portion F(t).

The control means comprise, in parallel:
the filter 6, and
the filters 7 then 5 in series, the filter 5 being placed between the filter 7 and the actuator 1.

The high-pass filter 5 is a first-order filter of pulse

$${ω}_{C} = \frac{1}{τ} \approx 0.071$$

rad/s and therefore having a cut-off frequency

$${f}_{C} = \frac{{ω}_{C}}{2 π} \approx 0.0 \; 11 Hz .$$

It does not affect the perception of a majority of persons 4.

It is noted that the cut-off frequency f_{c} of the filter 5 is:

less than 0.1 Hz and/or greater than 0.001 Hz,

preferably less than 0.05 Hz and/or greater than 0.003 Hz,

preferably less than 0.03 Hz and/or greater than 0.005 Hz,

preferably less than 0.0265 Hz and/or greater than 0.0057 Hz.

The equation of the transfer function (or transmittance) of the corresponding filter 5 is:

$$H ( j ω ) = \frac{j \frac{ω}{{ω}_{C}}}{1 + j \frac{ω}{{ω}_{C}}}$$

where f=ω/2π is the frequency of the signal entering the filter 5.

The filter 5 is present in the form of an electronic board or in a form programmed by the software means of a computer forming part of the control means 2.

The interface 101 also comprises means for measuring the force exerted by the actuator 1 and feedback means of the force exerted by the actuator 1 according to the converted command. Such feedback makes it possible to ensure the correct value of the force exerted by the actuator 1 at each time t as a function of the converted command sent at time t by the control means 2 to the actuator 1.

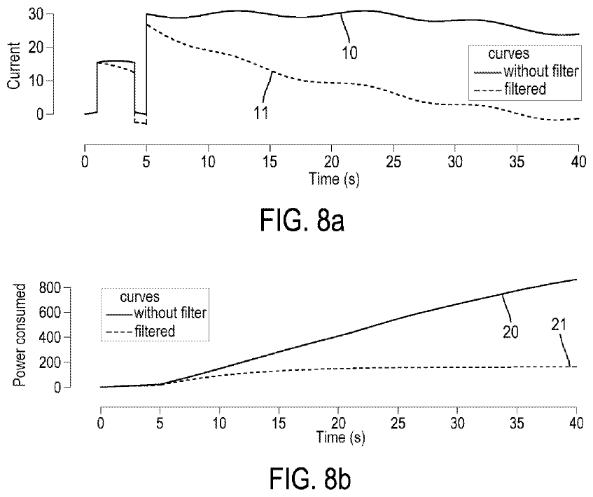

Now, several variants of a preferred embodiment of a method for controlling an interface 101 with haptic force feedback” said interface comprising the actuator 1, will be described with reference to FIGS. 4 to 8.

This embodiment of the method according to the invention comprises receiving the initial command arranged for controlling the actuator 1 so that the force exerted by the actuator 1 on the user 4 or the initial command is equal to:
the initial low-frequency portion F₀(t) comprising only frequencies less than the cut-off frequency,
plus the optional high-frequency portion \tilde{F}(t) comprising only frequencies greater than the cut-off frequency.

Initial Command: for F₀(t)+\tilde{F}(t)

This embodiment of the method according to the invention then comprises converting the initial command to the converted command in which the initial low-frequency portion F₀(t) (except preferably if it is a zero constant function) is converted to a modified low-frequency portion F(t), the amplitude of which follows a decreasing function, and for which, over any time interval of duration Δt between a time t and a time t+Δt, the modified low-frequency portion F(t) decreases in amplitude by a value X less than or equal to 10% of the initial value of the modified low-frequency portion F(t) at time t, the duration Δt of the time interval being greater than or equal to 0.3 second:

### Initial Command: for F₀(t)+\tilde{F}(t)

### =>Converted Command: for F(t)+\tilde{F}(t)

This embodiment of the method according to the invention then comprises controlling the actuator according to the converted command.

The lower or upper values given above within the framework of the description of the interface 101 for the value X and the duration Δt remain valid.

The low-frequency portion F(t) modified as a function of time t is a decreasing function and is:
preferably an exponential function in the form

$$F ( t ) = A \cdot exp ( ( \frac{- r}{τ} ) ) + B ,$$

(in the case of FIGS. 5 to 7) the constant A being a positive real number, the constant B being a real number, the constant τ being a positive real number. Typically, A=15, B=0, and τ=14 in the specific and non-limitative case of FIG. 6. This therefore gives the following conversion:

$$Initial comman \text{d:} = {F}_{0} ( t ) + \tilde{F} ( t ) \\ = > Converted comman \text{d:} for A \cdot exp ( ( \frac{- t}{τ} ) ) + B + \tilde{F} ( t )$$

The lower or upper values given above within the framework of the description of the interface 101 for the constant τ remain valid.

or another type of function, for example linear or polynomial or other or more complex according to the action of the high-pass filter 5.

This conversion of the initial command to the converted command is preferably implemented by applying the high-pass filter 5 described above.

This embodiment of the method according to the invention comprises measuring the force exerted by the actuator 1, and feedback of the force exerted by the actuator 1 according to the converted command, typically by a proportional-integral-derivative (PID) regulator loop.

This embodiment of the method according to the invention is implemented over a total duration of at least 1 second, preferably at least 1.4 seconds, preferably at least 2 seconds, preferably at least 3 seconds, preferably at least 10 seconds.

Each of the variants in FIGS. 4 to 8 of this embodiment of the method according to the invention corresponds to the case in which:
the method according to the invention is implemented starting from t=0 s.
Starting from the implementation of the method according to the invention:
   The initial command is converted to the converted command in which the initial low-frequency portion F₀(t) is converted (except if F₀(t) is a zero constant function, for example from t=0 s to t=1 s in FIG. 6a and from t=0 s to t=5 s in FIG. 7a) in the modified low-frequency portion F(t), which follows a decreasing function and for which, over any time interval of duration Δt between a time t and a time t+Δt, the modified low-frequency portion F(t) decreases by a value X substantially equal to 10% of the initial value of the modified low-frequency portion F(t) at time t, for a duration Δt of the time interval substantially equal to 0.5 second,
   The user 4 does not feel the reduction of the force exerted by the actuator 1, even if it reduces; this allowing a saving of dissipated energy and the use of a motor or actuator 1 of small dimensions.

If F(t) corresponds to a force instruction for the actuator 1, A and B have a Force dimension, typically in Newtons.

If F(t) corresponds to a portion of the control signal for the actuator 1, A and B have a voltage or amperage dimension, typically in Volts or Amperes.

For each of FIGS. 4 to 8, F(t) corresponds to a portion of the control signal for the actuator 1, A and B have an amperage dimension, typically in Amperes, and the force or the torque produced by an interface 101 is proportional to the electric current of the signal F(t)+\tilde{F}(t) on the y-axis in FIGS. 4 to 8.

In each of FIGS. 4 to 8:
reference 10 refers to the initial control signal F₀(t)+\tilde{F}(t);
reference 11 refers to the converted control signal F(t)+\tilde{F}(t);
the converted control signal F(t)+\tilde{F}(t) is obtained by applying the high-pass filter 5 described above;
reference 20 refers to the power consumed by the actuator 1 if the latter was actuated by the initial control signal F₀(t)+\tilde{F}(t);
reference 21 refers to the power consumed by the actuator 1 when the latter is actuated by the converted control signal F(t)+\tilde{F}(t);
the unit of the y-axes of FIGS. 4a, 5a, 6a, 7a, and 8a is proportional to Amperes,
the unit of the y-axes of FIGS. 4b, 5b, 6b, 7b, and 8b is proportional to Joules,
the unit of the x-axes of FIGS. 4a, 4b, 5a, 5b, 6a, 6b, 7a, 7b, and 8a, 8b is seconds.

The case of FIGS. 4a and 4b corresponds to the case where the high-frequency portion \tilde{F}(t) comprises a bump 12 which is thus found on the two curves 10 and 11.

The case of FIGS. 5a and 5b corresponds to the case where the initial command F₀(t)+\tilde{F}(t) corresponds to alternating crenellations.

The high-frequency portion \tilde{F}(t) thus comprises abrupt variations 22 that are thus found on the two curves 10 and 11.

The modified low-frequency portion F(t) is the exponential function of the form

$$F ( t ) = A \cdot exp ( ( \frac{- t}{τ} ) ) + B$$

wherein the values of A, B (and optionally τ) can change at each crenellation.

FIG. 5a clearly shows that the modified low-frequency portion F(t) follows “in amplitude” a globally decreasing function over Δt, i.e.:

when this function F(t) is negative, it increases globally over Δt,

when this function F(t) is positive, it decreases globally over Δt.

The case of FIGS. 6a and 6b corresponds to the case where the initial command F₀(t)+\tilde{F}(t) corresponds to a non-zero constant (starting from t=1 s).

Starting from t=1 s, F₀(t) is therefore a constant, while the modified low-frequency portion F(t) is a function in the form

$$F ( t ) = A \cdot exp ( ( \frac{- t}{τ} ) ) + B .$$

The case of FIGS. 7a and 7b corresponds to the case where the initial command F₀(t)+\tilde{F}(t) corresponds to steps of a staircase.

The high-frequency portion \tilde{F}(t) thus comprises abrupt variations 72 that are thus found on the two curves 10 and 11.

The modified low-frequency portion F(t) is a function in the form

$$F ( t ) = A \cdot exp ( ( \frac{- t}{τ} ) ) + B .$$

The case of FIGS. 8a and 8b corresponds to a more complex case, where the initial command F₀(t)+\tilde{F}(t) comprises abrupt variations, undulations, etc.

Of course, the invention is not limited to the examples which have just been described, and numerous modifications can be made to these examples without departing from the scope of the invention.

For example, in variants that can be combined together and with the embodiments previously described:

the actuator 1 is arranged to exert forces along several axes of interface comprising one or more axes of translation, the actuator 1 being arranged to exert forces parallel to each of these axes of translation, and/or one or more axes of rotation, the actuator 1 being arranged to exert a torque about each of these axes of rotation. In this case, the control means 2 are arranged and/or programmed to receive the initial command, convert the initial command to the converted command, and control the actuator according to the converted command along at least one of these axes, preferably along several of these interface axes or even along all these interface axes. The actuator 1 exerts forces along several interface axes, and the method according to the invention is applied to at least one of these interface axes, preferably to several of these interface axes or even to all these interface axes, and/or

the actuator 1 can for example be:
a handle, or
a biological and/or chemical muscle and/or actuator, for example in the case of an interface 101 for muscular exercise. In this case, the converted command is sent to the actuator/muscle via electrodes adhered to the skin surrounding the actuator/muscle of a user, and/or

it is not necessarily the modified low-frequency portion F(t), but as a minimum the arithmetic mean of F(t), the amplitude (or absolute value) of which follows a decreasing function, and for which, over any time interval of duration Δt between a time t and a time t+Δt, the arithmetic mean of the modified low-frequency portion F(t) decreases in amplitude (or in absolute value) by a value X less than or equal to 10% of the initial value of the modified low-frequency portion F(t) at time t, the duration Δt of the time interval being greater than or equal to 0.3 second, and/or

the filters 6 and 7 are optional. Thus, in a variant with reference to FIG. 2, the branch comprising the filter 6 is omitted (therefore there are no longer two branches in parallel), and the second branch comprises the filter 5 but has its filter 7 omitted. By itself, the high-pass filter 5, with its technical characteristics as defined above in the description, can make it possible to convert the initial low-frequency portion F₀(t) to the modified low-frequency portion F(t) without modifying the high-frequency portion \tilde{F}(t) so that the converted command is equal to F(t)+\tilde{F}(t).

Of course, the different characteristics, forms, variants and embodiments of the invention can be combined together in various combinations, provided they are not incompatible or mutually exclusive. In particular, all the variants and embodiments described above can be combined together.

1. A method for controlling an interface with haptic force feedback, said interface comprising an actuator, said method comprising:
receiving an initial command arranged for controlling the actuator so that a force exerted by the actuator or the initial command is equal to:
an initial low-frequency portion F₀(t) comprising only frequencies less than a cut-off frequency,
plus an optional high-frequency portion \tilde{F}(t) comprising only frequencies greater than the cut-off frequency,
converting the initial command to a converted command in which the initial low-frequency portion F₀(t) is converted to a modified low-frequency portion F(t), the amplitude of which follows a decreasing function, and for which, over any time interval of duration Δt between a time t and a time t+Δt, the modified low-frequency portion F(t) decreases by a value X less than or equal to 10% of the initial value of the modified low-frequency portion F(t) at time t, the duration Δt of the time interval being greater than or equal to 0.3 second; and
controlling the actuator according to the converted command.

2. The method according to claim 1, characterized in that the value X is greater than or equal to 1%, preferably 5%, of the initial value of F(t) at time t.

3. The method according to claim 1, characterized in that the duration Δt of the time interval is greater than or equal to 0.5 second, preferably greater than or equal to 1 second, preferably greater than or equal to 1.4 seconds, preferably greater than or equal to 2 seconds, preferably greater than or equal to 3 seconds.

4. The method according to claim 1, characterized in that the duration Δt of the time interval is less than or equal to 60 seconds, preferably less than or equal to 30 seconds, preferably less than or equal to 10 seconds.

5. The method according to claim 1, characterized in that the decreasing function of the modified low-frequency portion F(t) as a function of time t is an exponential function in the form
$$F ( t ) = A \cdot exp ( ( \frac{- t}{τ} ) ) + B ,$$
the constant A being a positive real number, the constant B being a real number, the constant τ being a positive real number.

6. The method according to claim 5, characterized in that the constant τ is a positive real number greater than or equal to 1 second, preferably greater than or equal to 5 seconds, preferably greater than or equal to 10 seconds.

7. The method according to claim 5, characterized in that the constant τ is a positive real number less than or equal to 60 seconds, preferably less than or equal to 50 seconds, preferably less than or equal to 40 seconds.

8. The method according to claim 1, characterized in that the conversion of the initial command to the converted command comprises applying a high-pass filter.

9. The method according to claim 1, characterized in that it comprises measuring the force exerted by the actuator, and feedback of the force exerted by the actuator according to the converted command.

10. The method according to claim 1, characterized in that it is implemented over a total duration of at least 1 second.

11. The method according to claim 1, characterized in that the actuator exerts forces along several axes, said method being applied to at least one of these axes.

12. The method according to claim 1, characterized in that the cut-off frequency is less than or equal to 10 Hz.

13. An interface with haptic force feedback, comprising:
control means, arranged and/or programmed for:
receiving an initial command arranged for controlling an actuator so that a force exerted by the actuator or the initial command is equal to:
an initial low-frequency portion F₀(t) comprising only frequencies less than a cut-off frequency,
plus an optional high-frequency portion \tilde{F}(t) comprising only frequencies greater than the cut-off frequency;
converting the initial command to a converted command in which the initial low-frequency portion F₀(t) is converted to a modified low-frequency portion F(t), the amplitude of which follows a decreasing function, and for which, over any time interval of duration Δt between a time t and a time t+Δt, the modified low-frequency portion F(t) decreases by a value X less than or equal to 10% of the initial value of the modified low-frequency portion F(t) at time t, the duration Δt of the time interval being greater than or equal to 0.3 second; and
controlling the actuator according to the converted command.
